(19) United States
(12) Patent Application Publication
(10) Pub. No.: US 2024/0378821 A1
(43) Pub. Date: Nov. 14, 2024

(54) LOCALIZED ENVIRONMENTAL INPUT SENSING FOR ELECTRONIC DEVICES

(71) Applicant: Apple Inc., Cupertino, CA (US)

(72) Inventors: Ranjit DESAI, Cupertino, CA (US); Maneli NOORKAMI, Menlo Park, CA (US); Michael J. ROCKWELL, Palo Alto, CA (US)

(21) Appl. No.: 18/648,269

(22) Filed: Apr. 26, 2024

Related U.S. Application Data
(60) Provisional application No. 63/466,224, filed on May 12, 2023.

(51) Int. Cl. G06T 19/00; G02B 27/00; G06T 7/20; G06T 7/40; G06V 40/10; G06V 40/20

(52) U.S. Cl. CPC G06T 19/006; G02B 27/0093; G06T 7/20; G06T 7/40; G06V 40/10; G06V 40/20

(57) ABSTRACT

Aspects of the subject technology may provide localized environmental input sensing for electronic devices. Localized environmental input sensing may include obtaining local lighting condition estimates for one or more local portions of a physical environment. The local lighting conditions may include ambient light levels and/or a light direction of a directional light source. The one or more local portions of the physical environment may be determined based on an identification of a salient region of the physical environment to a user of an electronic device.

### CROSS REFERENCE TO RELATED APPLICATIONS

This application claims the benefit of priority to U.S. Provisional Patent Application No. 63/466,224, entitled, “Localized Environmental Input Sensing for Electronic Devices”, filed on May 12, 2023, the disclosure of which is hereby incorporated herein in its entirety.

### TECHNICAL FIELD

The present description relates generally to electronic devices, including, for example, localized environmental input sensing for electronic devices.

### BACKGROUND

Electronic devices are often provided with a camera for capturing images. Captured images from the camera can be displayed, stored in memory of the electronic device, sent to other electronic devices, and/or used to detect objects in the images. Some electronic devices include an ambient light sensor that senses the overall amount of ambient light in the physical environment of the electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 illustrates a block diagram of example features of an electronic device in accordance with one or more implementations.

FIG. 3 illustrates a schematic diagram illustrating processing chains that may utilize environmental condition estimates in accordance with one or more implementations.

FIG. 4 illustrates an example physical environment including various environmental conditions in accordance with one or more implementations.

FIG. 5 illustrates an example saliency-based environmental condition estimation, in accordance with one or more implementations.

FIG. 6 illustrates an example saliency map in accordance with one or more implementations.

FIG. 7 illustrates another example saliency map in accordance with one or more implementations.

FIG. 8 illustrates a flow chart of example operations for performing localized environmental input sensing for electronic devices in accordance with one or more implementations.

FIG. 9 illustrates flow chart of example operations for performing localized environmental input sensing in a salient region of a physical environment in accordance with one or more implementations.

FIG. 10 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/carphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Aspects of the subject technology may provide localized environmental input information that can be used by various processing stages of various processing pipelines of an electronic device, such as an electronic device that generates a three-dimensional scene (e.g., an XR environment) and/or performs spatial computing operations. For example, the localized environmental input information may include local environmental conditions such as local lighting conditions in a region of the physical environment that is within, and smaller than, the field-of-view of the three-dimensional scene generated by the electronic device. Local lighting conditions may include local ambient light levels and/or lighting directions in various respective local portions of the physical environment. These local lighting conditions can be provided to various processing stages of various processing pipelines for computer vision, hand tracking, three-dimensional immersion effects generation, spatial computing, image pre-processing, image and/or video processing (e.g., including spatial and/or immersive video capturing, generating, and/or processing), spatial mapping, surface and/or texture estimates, shape and/or geometry estimates, materials estimates, object tracking, scene reconstructions, and/or spatial audio processes (as examples) that could otherwise be negatively affected by a global lighting condition estimate that does not sufficiently represent the details of lighting environment. For example, the local lighting conditions can allow various processing pipelines to correctly account for brightness discontinuities, directional lighting features, and/or other discontinuities in the physical environment that would not be reflected in a global lighting condition estimate.

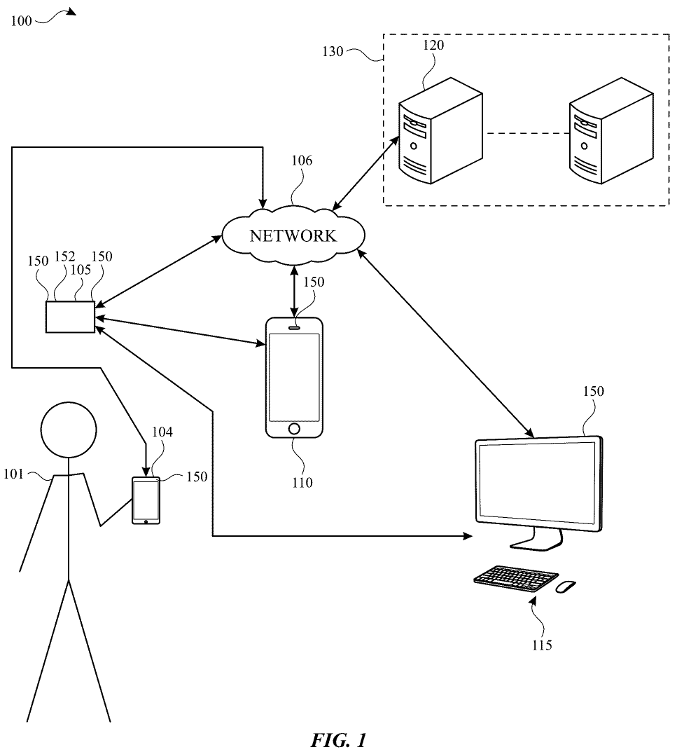

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 may be implemented, for example, as a tablet device, a smartphone, or as a head mountable portable system (e.g., worn by a user 101). The electronic device 105 includes a display system capable of presenting a visualization of an extended reality environment to the user. The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In one or more implementations, instead of, or in addition to, utilizing the electronic device 105 to access an extended reality environment, the user may use a handheld electronic device 104, such as a tablet, watch, mobile device, and the like.

The electronic device 105 may include one or more cameras such as camera(s) 150 (e.g., visible light cameras, infrared cameras, etc.) For example, the electronic device 105 may include multiple cameras 150. For example, the multiple cameras 150 may include a left facing camera, a front facing camera, a right facing camera, a down facing camera, a left-down facing camera, a right-down facing camera, an up facing camera, one or more eye-facing cameras, and/or other cameras. Each of the cameras 150 may include one or more image sensors (e.g., charged coupled device (CCD) image sensors, complementary metal oxide semiconductor (CMOS) image sensors, or the like).

Further, the electronic device 105 may include various sensors 152 including, but not limited to, other cameras, other image sensors, touch sensors, ambient light sensors, microphones (e.g., sound level microphones), inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User inputs detected by such cameras, sensors, and/or hardware elements may correspond to, for example, various input modalities. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. In one or more implementations, facial tracking, gaze tracking, hand tracking, gesture tracking, object tracking, and/or physical environment mapping processes (e.g., system processes and/or application processes) may utilize images (e.g., image frames) captured by one or more image sensors of the cameras 150 and/or the sensors 152.

In one or more implementations, the electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging and/or providing power to the electronic device 105 while physically connected).

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an implementation, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner. In an example, the electronic device 105 provides a rendering of a scene corresponding to the extended reality environment that can be perceived by the user and interacted with in a real-time manner, such as a host environment for a group session with another user. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload. The electronic device 105 may be, and/or may include all or part of, the electronic system discussed below with respect to FIG. 10.

The network 106 may communicatively (directly or indirectly) couple, for example, the electronic device 105, the electronic device 110, and/or the electronic device 115 with each other device and/or the server 120. In one or more implementations, the network 106 may be an interconnected network of devices that may include, or may be communicatively coupled to, the Internet.

The electronic device 110 may include one or more cameras 150 (e.g., multiple cameras 150) and may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers 211, a touchscreen, and/or a touchpad. In one or more implementations, the electronic device 110 may not include a touchscreen but may support touchscreen-like gestures, such as in an extended reality environment. In one or more implementations, the electronic device 110 may include a touchpad. In FIG. 1, by way of example, the electronic device 110 is depicted as a mobile smartphone device. In one or more implementations, the electronic device 110, the handheld electronic device 104, and/or the electronic device 105 may be, and/or may include all or part of, the electronic system discussed below with respect to FIG. 10. In one or more implementations, the electronic device 110 may be another device such as an Internet Protocol (IP) camera, a tablet, or a companion device such as an electronic stylus, etc.

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer having one or more cameras 150 (e.g., multiple cameras 150). The electronic device 115 may be, and/or may include all or part of, the electronic system discussed below with respect to FIG. 10.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an implementation, the server 120 may function as a cloud storage server that stores any of the aforementioned extended reality content generated by the above-discussed devices and/or the server 120.

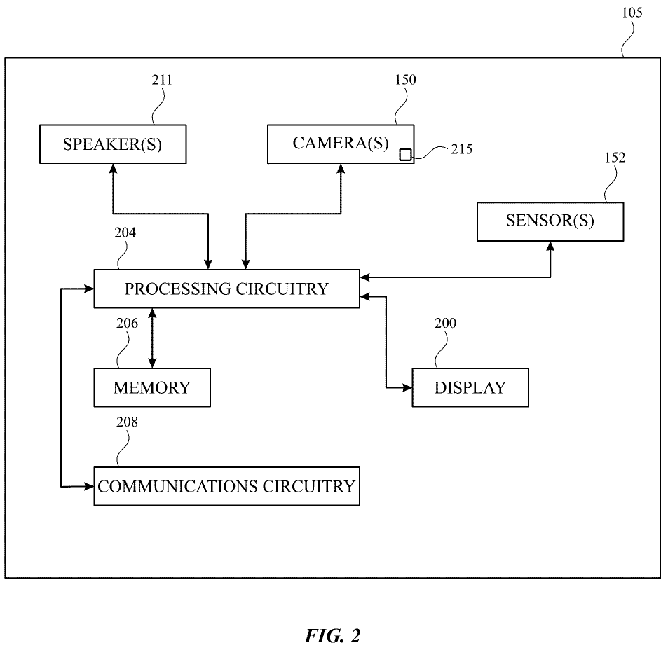

FIG. 2 illustrates a block diagram of various components that may be included in electronic device 105, in accordance with aspects of the disclosure. As shown in FIG. 2, electronic device 105 may include one or more cameras such as camera(s) 150 (e.g., multiple cameras 150, each including one or more image sensors 215) that capture images and/or video of the physical environment around the electronic device, one or more sensors 152 that obtain environment information (e.g., depth information) associated with the physical environment around the electronic device 105. Sensors 152 may include depth sensors (e.g., time-of-flight sensors, infrared sensors, radar, sonar, lidar, etc.), one or more microphones (e.g., including sound level microphones), light sensors such as ambient light sensors, and/or other types of sensors for sensing the various attributes of the physical environment, such as one or more colors, one or more brightnesses, one or more depths, one or more sounds levels, etc., For example, one or more microphones included in the sensor(s) 152 may be operable to capture audio input from a user of the electronic device 105, such as a voice input corresponding to the user speaking into the microphones, and/or to determine the level of ambient sound in one or more portions of the physical environment. In the example of FIG. 2, electronic device 105 also includes communications circuitry 208 for communication with electronic device 110, electronic device 115, servers 120, and/or other devices and/or systems in some implementations. Communications circuitry 208 may include radio frequency (RF) communications circuitry for detecting radio frequency identification (RFID) tags, Bluetooth Low Energy (BLE) communications circuitry, other near-field communications (NFC) circuitry, WiFi communications circuitry, cellular communications circuitry, and/or other wired and/or wireless communications circuitry.

As shown, electronic device 105 includes processing circuitry 204 (e.g., one or more processors and/or integrated circuits) and memory 206. Memory 206 may store (e.g., temporarily or permanently) content generated by and/or otherwise obtained by electronic device 105. In some operational scenarios, memory 206 may temporarily store images of a physical environment captured by camera(s) 150, depth information corresponding to the images generated, for example, using a depth sensor of sensors 152, meshes and/or textures corresponding to the physical environment, virtual objects such as virtual objects generated by processing circuitry 204 to include virtual content, and/or virtual depth information for the virtual objects. Memory 206 may store (e.g., temporarily or permanently) intermediate images and/or information generated by processing circuitry 204 for combining the image(s) of the physical environment and the virtual objects and/or virtual image(s) to form, e.g., composite images for display by display 200, such as by compositing one or more virtual objects onto a pass-through video stream obtained from one or more of the cameras 150.

As shown, the electronic device 105 may include one or more speakers 211. The speakers may be operable to output audio content, including audio content stored and/or generated at the electronic device 105, and/or audio content received from a remote device or server via the communications circuitry 208.

Memory 206 may store instructions or code for execution by processing circuitry 204, such as, for example operating system code corresponding to an operating system installed on the electronic device 105, and application code corresponding to one or more applications installed on the electronic device 105. The operating system code and/or the application code, when executed, may correspond to one or more operating system level processes and/or application level processes, such as processes that support capture of images, obtaining and/or processing environmental condition information, and/or determination of inputs to the electronic device 105 and/or outputs (e.g., display content on display 200) from the electronic device 105.

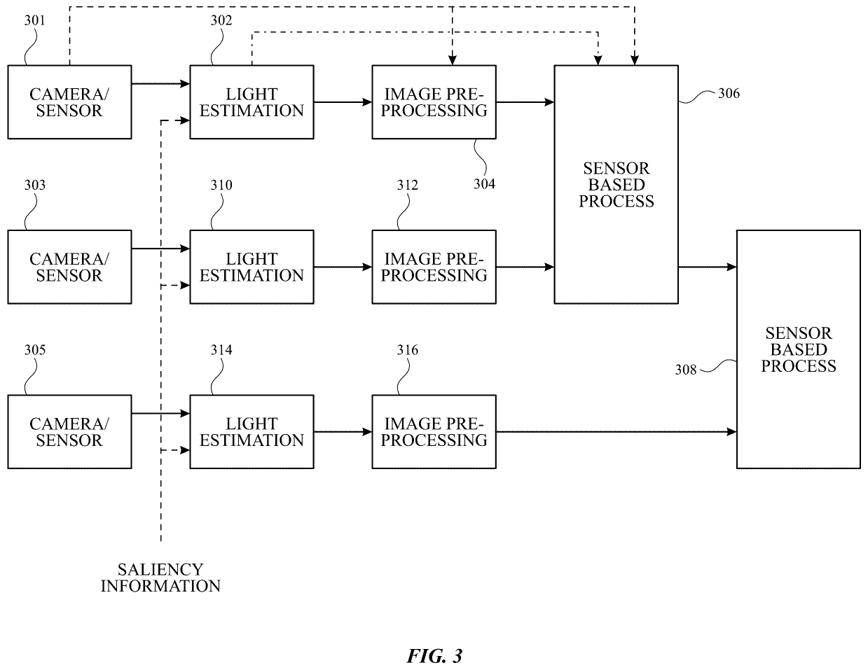

FIG. 3 illustrates aspects of various processing chains that can utilize environmental condition estimates, such as lightning condition estimates. As illustrated in FIG. 3, multiple cameras and/or sensors may generate images and/or sensor data. In the example of FIG. 3, a first camera/sensor 301 (e.g., a camera 150 or a sensor 152), a second camera/sensor 303 (e.g., a camera 150 or a sensor 152), and a third camera/sensor 305 (e.g., a camera 150 or a sensor 152) may generate sensor data (e.g., visible spectrum images, infrared (IR) images, depth information, and/or other sensor data). The first camera/sensor 301, the second camera/sensor 303, the third camera/sensor 305 and/or other cameras/sensors of the electronic device 105 can be configured differently (e.g., with different color spaces, quantizations, exposure times, sampling frequencies) from each other and/or for different XR and/or spatial computing outputs being generated by the electronic device 105. Moreover, as shown in FIG. 3, the outputs of the first camera/sensor 301, the second camera/sensor 303, and the third camera/sensor 305 may be fed to any of various software and/or hardware processes in one or more processing chains.

In the example of FIG. 3, the output of the first camera/sensor 301 is provided to light estimation process 302. The light estimation process 302 may determine one or more local lighting conditions (e.g., ambient light level, light direction, etc.) and/or one or more other local environmental conditions (e.g., color, texture, etc.) for one or more respective portions of a physical environment of the electronic device 105, as discussed in further detail hereinafter. The local lighting conditions and/or other local environmental conditions may be local to a spatial portion of a physical environment and/or local to a time at or around a particular observation of the condition(s). In one or more implementations, local lighting conditions and/or other local environmental conditions may be smoothed, filtered, or averaged over time. In one or more implementations, local lighting conditions and/or other local environmental conditions may be stored for various different observation times (e.g., with various different lighting conditions and/or various different viewing angles).

In one or more implementations, the light estimation process 302 may perform local light estimation based, in part, on saliency information that indicates that one or more portions of the physical environment are salient to a user of the electronic device 105. The saliency information may include, or may be derived (e.g., by the light estimation process(es) or by another process at the electronic device) from the location of a user's hand, the location of a user's gaze, and/or objects detected and/or identified in the physical environment, as discussed in further detail hereinafter. As described in further detail hereinafter, the saliency information may be provided as one or more saliency maps. The saliency map(s) may be provided as an input to the light estimation process 302, or may be generated by the light estimation process 302 based on other saliency information (e.g., user action and/or gaze information). In one or more implementations, a local lighting condition and/or other local environmental condition may be determined recursively at multiple resolutions and saliency levels. In one or more implementations, multiple local lighting conditions (e.g., an ambient light level, a light color, and/or a light direction) and/or multiple other local environmental conditions (e.g., a color, a texture, and/or other features of physical object) may be obtained for each of one or more local portions of the physical environment.

As shown in FIG. 3, the output (e.g., one or more local lighting conditions) of the light estimation process 302 may be provided to an image pre-processing operation 304. For example, the image pre-processing operation 304 may include noise reduction, signal-to-noise improvement, image enhancement, color transformation, compression, and/or refinement of image features for subsequent sensor-based processes. As shown, the output of the image pre-processing operations 304 may be provided to a sensor-based process 306. As an example, the sensor-based process 306 may include a computer-vision process that performs object detection, object recognition, and/or object tracking of one or more physical objects in a physical environment of the electronic device 105. The sensor-based process 306 may also, or alternatively, include materials estimations (e.g., surface texture estimations) in one or more implementations.

As shown, the output of the sensor-based process 306 may be provided to one or more other sensor-based processes (e.g., sensor-based process 308). For example, the sensor-based process 308 may include a gesture detection process that utilizes a hand-tracking output of the sensor-based process 306. As another example, the sensor-based process 308 may be a scene reconstruction process that utilizes one or more meshes, textures, and/or other three-dimensional environmental information generated by the sensor-based process 306 to generate a three-dimensional reconstruction of the physical environment. As another example, the sensor-based process 308 may include a three-dimensional immersion effect generation process that operates based on sensor data and/or lighting condition estimates to generate immersive effects for a three-dimensional scene. As another example, the sensor-based process 308 and/or another sensor-based process subsequent to the sensor-based process 308 may generate, using the local lighting conditions estimated by the light estimation process 302, the light estimation process 310, and/or the light estimation process 314, and sensor data from the camera sensor 301, the camera/sensor 303, and/or the camera/sensor 305 (e.g., one or more images from the one or more cameras 150), a three-dimensional scene (e.g., an XR scene) for display by the electronic device, the three-dimensional scene including: a view of a region of the physical environment that is based on the one or more images from the one or more cameras, and virtual content overlaid on the view of the region of the physical environment.

As another example, the sensor-based process 308 may include a spatial audio generation process that utilizes three-dimensional geometries and/or surface textures derived by the sensor-based process 306. For example, an output of the sensor-based process 306 (e.g., in an example in which the sensor-based process 306 is implemented as a visual algorithm such as a scene reconstruction algorithm or a computer vision algorithm that may identify walls, a table, a chair, a fabric, wood, glass, or other materials) may be used by the sensor-based process 308 to generate spatial audio that is provided directly from a speaker to the car(s) of a user, but that is apparently reflected and/or absorbed by physical features of the physical environment in the way that sound that propagates through the physical environment itself would be reflected and/or absorbed. In one or more implementations, the sensor-based process 306 may convert identified environmental aspects such as detected objects, textures, and/or materials into a mesh which can be fed into the sensor-based process 308 to perform spatial audio rendering. In one or more implementations, spatial audio rendering may include determining reverb and/or other spatial characteristics of an audio output based on computations of reflections or absorptions by the environmental conditions identified in the mesh.

As another example, the sensor-based process 306 and/or the sensor-based process 308 may be or include spatial computing processes. For example, spatial computing processes may be performed for detecting and/or facilitating user interaction with virtual and/or real objects (e.g., in an XR environment, such as an AR or MR environment) via an electronic device. Spatial computing may be performed, for example, for creating memories such as spatial images, spatial videos and/or spatial audio recordings, playing spatial games, etc. Spatial computing may include computing processes associated with XR, VR, AR, and/or MR experiences, machine learning, neural networks, and/or artificial intelligence, and/or any computing process that involves user inputs to, and/or user outputs from, an electronic device in which the electronic device obtains, stores, and/or processes spatial information associated with physical objects and/or environments. Spatial computing processes can include, as examples, user interaction processes and/or memory creation processes (e.g., spatial imaging, spatial video recording, and/or immersive video and/or other immersive experiences).

As shown, the image pre-processing operations 304, the sensor-based process 306, and/or the sensor-based process 308 may each receive an output of an earlier (e.g., preceding) processing stage in the processing chain that includes the light estimation process 302, the image pre-processing operations 304, the sensor-based process 306, and the sensor-based process 308. As shown, the image pre-processing operations 304, the sensor-based process 306, and/or the sensor-based process 308 may each also, optionally, receive the output of the camera/sensor 301 and/or the light estimation process 302.

FIG. 3 also shows how the processing chain that includes the light estimation process 302, the image pre-processing operations 304, the sensor-based process 306, and the sensor-based process 308 may be integrated with one or more other processing chains performed by the electronic device 105. For example, the sensor-based process 306 may operate on the output of the image pre-processing operations 304 and on the output of image pre-processing operations 312 that receive, in a parallel processing chain, an output of a light estimation process 310 that uses the output of the camera/sensor 303. As shown, the sensor-based process 308 may operate on the output of the sensor-based process 306 and the output of image pre-processing operations 316 that receive, in yet another parallel processing chain, an output of a light estimation process 314 that uses the output of the camera/sensor 305.

The example interconnected processing chains of FIG. 3 illustrate how an environmental condition estimate, such as a lighting condition estimate (e.g., an ambient light level, a directional lighting estimate, a color estimate, a texture estimate, a material estimate, and/or the like), in the first or early stages of a processing chain can affect multiple subsequent processing stages in that and/or other processing chains that ultimately lead to determination of user inputs and/or to generation of outputs from an electronic device. For example, estimation of directional light sources and/or ambient light levels may play a major role in inferring other properties of the physical environment in XR and/or spatial computing experiences. Accordingly, an inaccurate environmental condition estimate, such as an inaccurate lighting condition estimate, can result in errors that propagate and/or accumulate through the processing chain(s), which can lead to visual and/or audio output artifacts and a degraded user experience.

As described in further detail hereinafter, aspects of the subject technology provide a robust environmental condition estimator (e.g., light estimation processes 302, 310, and/or 314) that can handle spatially and temporally variable lighting environments and/or other spatially and temporally variable environmental conditions (e.g., color, texture, sound, etc.). In one or more implementations, the light estimation processes described herein take saliency into account. For example, the light estimation processes 302, 310, and/or 314 may use saliency information to estimate local lighting and/or other environmental conditions in specific parts of the physical environment. For example, the light estimation processes 302, 310, and/or 314 may build environmental condition estimates based on a saliency map (e.g., derived from user gaze information, user history information, user gestures, environmental sensing algorithms, detected objects, identified objects, and/or user annotations) that guides a sampling strategy used by the light estimation process(es). In various implementations, the light estimation processes 302, 310, and/or 314 may generate local environmental condition estimates, such as local lighting condition estimates, that account for (a) local discontinuities in lighting and geometry, (b) temporal changes (e.g., due to device and/or user motion) in the physical environment, and/or (c) prior information about the environment. In one or more implementations, light estimation processes 302, 310, and/or 314 may use a combination of local probability maps (e.g., maps of saliency probability), geometric information, and/or temporal variance.

In one or more implementations, the sensor-based process 306, the sensor-based process 308, and/or other processes and/or processing chains that may be performed based on sensor information (e.g., including images from one or more cameras 150) and based on local environmental conditions (e.g., based on local lighting conditions) may be implemented as neural networks. In one or more implementations, the light estimation processes disclosed herein may be implemented as a preprocesses (e.g., as one or more initial layers) of a neural network including the sensor-based process 306, the sensor-based process 308, and/or other processes and/or processing chains that may be performed based on sensor information and based on local environmental conditions. In one or more implementations, the sensor-based process 306, the sensor-based process 308, and/or other processes and/or processing chains that may be performed based on sensor information (e.g., including images from one or more cameras 150) and based on local environmental conditions (e.g., based on local lighting conditions) may be encapsulated in one or more neural networks that can be trained and/or learn in context (e.g., during user operation of the electronic device 105). For example, performing ongoing training of the neural network(s) in context can allow the various sensor-based processes and/or other processes and/or processing chains to be adaptable in different environments (e.g., guided by user feedback or actions to adjust saliency).

The example of FIG. 3 includes three cameras/sensors, three light estimation processes, three image pre-processors, and two sensor-based processes. However, this is merely illustrative and, in one or more other implementations, the electronic device 105 may implement more or fewer processing chains than those depicted in FIG. 3, which may obtain sensor information from more or fewer than three cameras/sensors, and may incorporate more or fewer than three light estimators, more or fewer than three image pre-processors, and/or more or fewer than two sensor-based processes. It is also appreciated that the sensor-based process 306 and the sensor-based process 308 of FIG. 3 may operate based on sensor data received directly from one or more cameras and/or other sensors, and/or may operate on data that has been derived from sensor data from one or more cameras and/or other sensors. It is also appreciated that the processing chains used by an electronic device such as the electronic device 105 may be modified and/or varied to generate varying XR experiences. For example, various different processing stages of one or more processing chains can be chained together across modalities and/or application-specific operations, such as by “wiring together” any of various sensors (e.g., image sensors, video sensors, audio sensors, and/or motion sensors such as IMU sensors), hardware pre-processors (e.g., for image enhancement and/or signal processing), computer vision algorithms (e.g., to power capture and/or replay), 3D immersive processes, and/or spatial audio processes in various arrangements.

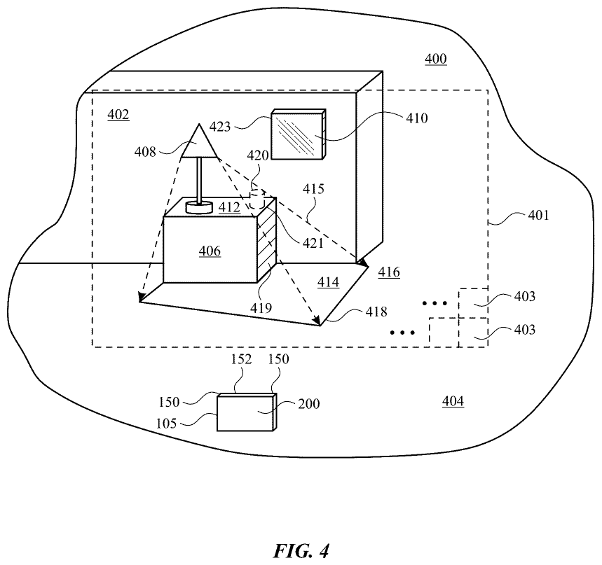

FIG. 4 illustrates an example physical environment 400 in which an electronic device, such as the electronic device 105, can be operated. In the example of FIG. 4, the physical environment 400 includes a physical wall 402, a physical floor 404, a physical table 406, a physical lamp 408, and a physical mirror 410. In other examples, the physical environment 400 can include any other physical objects, which may include more or fewer physical objects than those depicted in FIG. 4. FIG. 4 also illustrates an example field-of-view 401 corresponding to one or more of the cameras 150 of the electronic device 105. As examples, the field-of-view 401 may be the field-of-view of a single camera 150 of the electronic device 105, or a combined field-of-view of multiple cameras 150 of the electronic device 105. In one or more implementations, the field-of-view 401 may represent the field-of-view of a pass-through video stream being displayed by a display (e.g., display 200) of the electronic device 105 to represent the corresponding portion of the physical environment.

As discussed herein, in various use cases (e.g., XR, spatial computing), it can be helpful to have estimates of one or more environmental conditions (e.g., lighting conditions, colors, textures, etc.) of the physical environment 400. For example, in one or more use cases, the electronic device 105 may render virtual content (e.g., using the display 200 of the device) overlaid on a view of the physical environment 400, such that the virtual content appears to be located within the physical environment 400 at a location away from the electronic device 105. In the example of FIG. 4, a virtual cup 420 has been rendered by the electronic device 105 to appear, to a viewer of a display (e.g., display 200) of the electronic device 105, on a surface 412 of the physical table 406.

In order, for example, to render the virtual cup 420 on the surface 412 of the physical table 406, it can be helpful to have an estimate of the lighting conditions in the physical environment 400. For example, the electronic device 105 may render the virtual cup 420 with a brightness that depends on the brightness of the ambient light in the physical environment 400. For example, the electronic device 105 may render the virtual cup 420 with a relatively low brightness if the ambient light in the physical environment is relatively low, or with a relatively high brightness if the ambient light in the physical environment 400 is relatively high. As another example, electronic device 105 may modify the color of the virtual cup 420 based on the color of the ambient light in the physical environment 400, and/or based on the color of the surface 412 and/or the physical wall 402.

In some systems, a global lighting condition, such as a global ambient light level, may be obtained by an electronic device by averaging the brightness across the entire field of view 401 or by obtaining the ambient light level with a single pixel ambient light sensor. However, as discussed herein, a global ambient light level of this type can misrepresent the brightness of some or all of the physical environment 400, particularly in use cases in which, for example, the physical environment 400 includes a very bright region or a very dark region. For example, the physical environment 400 may include one or more brightness discontinuities between bright and dark regions of the physical environment.

In one or more use cases, the physical environment 400 may include a directional light source, such as the physical lamp 408 (e.g., or another directional light source such as a wall-mounted, or ceiling-mounted light source, or a window through which sunlight or street lamp light enters the physical environment 400). As illustrated in FIG. 4, the physical lamp 408 may generate directional light 415. This directional light 415 can interact with the surface 412 of the physical table 406 to generate a shadow 414 on the physical floor 404. This can generate, as examples, a bright region corresponding to the surface 412 of the physical table, a bright region corresponding to the physical lamp 408 itself, and a dark region corresponding to the shadow 414, all within the field-of-view 401. In the example physical environment 400 of FIG. 4, the physical mirror 410 may also reflect light from the physical lamp 408, generating another bright region in the field of view 401.

In the example of FIG. 4 in which the virtual cup 420 is rendered on the surface 412 (within the bright region of the physical environment 400 that is generated by the directional light 415), a global estimate of the light level in the physical environment 400 may cause the rendering of the virtual cup 420 to be difficult to view in the bright region corresponding to the surface 412. In the example of FIG. 4 in which the virtual cup 420 is rendered on the surface 412, a global estimate of the color of the physical environment 400 may also cause the rendering of the virtual cup 420 to be difficult to view if the color of the surface 412 is different from the global color estimate (e.g., if the color of the virtual cup 420 is determined to be a color that contrasts with the global color estimate).

The physical environment 400 can include light discontinuities such as brightness discontinuities, color discontinuities, texture discontinuities, or other visual discontinuities. For example, as shown in FIG. 4, within the field-of-view 401, the physical environment 400 may include a light discontinuity such as brightness discontinuity 418 between the shadow 414 and a lit portion 416 of the physical floor 404. As another example, within the field-of-view 401, the physical environment 400 may include a light discontinuity such as brightness discontinuity 421 between the brightly lit surface 412 of the physical table 406 and a side surface 419 of the physical table 406, the side surface 419 being in the shadow of the directional light 415. As another example, within the field-of-view 401, the physical environment 400 may include a light discontinuity such as brightness discontinuity 423 between the surface of the physical wall 402 and the surface of the physical mirror 410.

In one or more implementations, the electronic device 105 may perform operations (e.g., the sensor-based process 306 or the sensor-based process 308) to obtain information from (e.g., user interactions), or render virtual content into portions of the physical environment 400 on one or the other side of a brightness discontinuity 418, and/or on or over a brightness discontinuity 418. For example, a user of the electronic device 105 may perform a hand gesture while the hand of the user is partially within the shadow 414 and partially within a portion of the physical environment 400 that is directly lit by the physical lamp 408, resulting in a brightness discontinuity across the user's hand while the hand gesture is performed. In one or more implementations, the electronic device 105 may perform operations that depend on a direction of the light in the physical environment 400. For example, rendering the virtual cup 420 may include rendering the virtual cup 420 and a virtual shadow of the virtual cup 420, in which the position, size, and/or shape of the virtual shadow depends on the direction of the light at the apparent location of the virtual cup 420 in the physical environment 400.

In order, for example, to provide the electronic device 105 with the ability to obtain information (e.g., object tracking information, gesture information, acoustic environment information, etc.) from portions of the physical environment 400 on one or the other side of the brightness discontinuity and/or on or over a brightness discontinuity 418, the ability to render virtual content over portions of the physical environment 400 on one or the other side of the brightness discontinuity and/or on or over a brightness discontinuity 418, the ability to perform operations that depend on a direction of the light in the physical environment, and/or the ability to perform operations that depend on a color, texture, or material in the physical environment 400, the electronic device 105 determine multiple local lighting conditions and/or other local environmental conditions in multiple respective local portions 403 of the physical environment 400.

For example, the electronic device 105 may determine an ambient light level, a light direction, a color, a texture, a material, and/or other environmental aspect for each of the portions 403 of the physical environment 400. The environmental conditions obtained in each of the portions 403 of the physical environment 400 may then be provided to any processing stages (e.g., the image pre-processing operations 304, the image pre-processing operations 312, image pre-processing operations 316, the sensor-based process 306, and/or the sensor-based process 308) of any processing pipelines that utilize environmental condition information and/or that obtain information from and/or render virtual content into those respective regions. In this way, inaccurate, biased, and or otherwise erroneous environmental condition estimates can be prevented from being provided to and/or propagated by the processing pipelines and or sub-stages thereof at the electronic device 105 in one or more implementations.

In the example of FIG. 4, local environmental condition estimates may be obtained for portions 403 of the physical environment 400 covering the entire field-of-view 401. In various implementations, the size and/or shape of the portions 403 maybe the same across the field-of-view 401, or may vary across the field-of-view 401. In various implementations, the size and/or shape of the portions 403 may be constant across operational states of the electronic device 105, or may vary according to an operational state of the electronic device 105.

In some use cases, obtaining local environmental condition estimates for portions 403 of the physical environment 400 across the entire field-of-view 401 may be an inefficient use of device resources (e.g., processing resources, memory resources, and/or power resources). For example, in a use case in which the user of the electronic device 105 is performing hand gestures to interact with the virtual cup 420 on the surface 412 of the physical table 406, local environmental condition estimates in the lit portion 416 of the physical floor 404 may be unused by the processing pipelines and or sub-stages thereof that are active at the electronic device while the user interacts with the virtual cup 420.

As illustrated in FIG. 5, in one or more implementations, the electronic device 105 may obtain local environmental condition estimates (e.g., local lighting condition estimates) only in a salient region 500 of the physical environment 400. For example, the salient region 500 may be identified, by the electronic device 105, as being salient to a user of the electronic device 105 based on a user action within the salient region 500. For example, the salient region 500 may be identified by the electronic device 105 based on a user gesture (e.g., a hand gesture) within the salient region 500, a user gaze location within the salient region 500, and/or one or more objects detected and/or identified in the scene. For example, as illustrated by FIG. 5, a user of the electronic device may be gazing at a gaze location 502 corresponding to the location of the virtual cup 420. Responsive to determining the gaze location 502, the electronic device 105 may identify the salient region 500 as a region around the gaze location 502 (e.g., by identifying a region of a particular size or radius around the gaze location 502). In other examples, the salient region 500 may be determined based on a user gesture corresponding to the virtual cup 420, and/or based on a historical user interaction within the salient region 500 (e.g., a history of the user placing or interacting with virtual content on the surface 412 of the physical table 406, as learned by the electronic device 105 during use of the electronic device 105).

In one or more implementations, the electronic device 105 may determine environmental condition estimates for multiple portions 403 of the physical environment 400 within the salient region 500. In one or more other implementations, the electronic device 105 may determine a single environmental condition estimate for the entire salient region 500. The environmental condition estimate(s) within the salient region 500 may be provided to one or more processing pipelines and or sub-stages thereof (e.g., as described in connection with FIG. 3). For example, the environmental condition estimate(s) may be used for generating, using one or more images from one or more cameras 150, a three-dimensional scene for display by the electronic device 105, the three-dimensional scene including: a view of a region (e.g., field-of-view 401) of the physical environment 400 that is based on the one or more images from the one or more cameras 150, and virtual content (e.g., virtual cup 420) overlaid on the view of the region of the physical environment 400. In one or more implementations, the electronic device 105 may determine a portion (e.g., salient region 500) of a physical environment (e.g., physical environment 400) that is salient to a user of an electronic device; obtain an estimate of an environmental condition (e.g., a local lighting condition or other local environmental condition) of the physical environment locally in the portion of the physical environment; and determine an input (e.g., a hand gesture) to the electronic device or an output (e.g., virtual content, such as virtual cup 420) of the electronic device based at least in part on the estimate of the environmental condition of the physical environment locally in the portion of the physical environment.

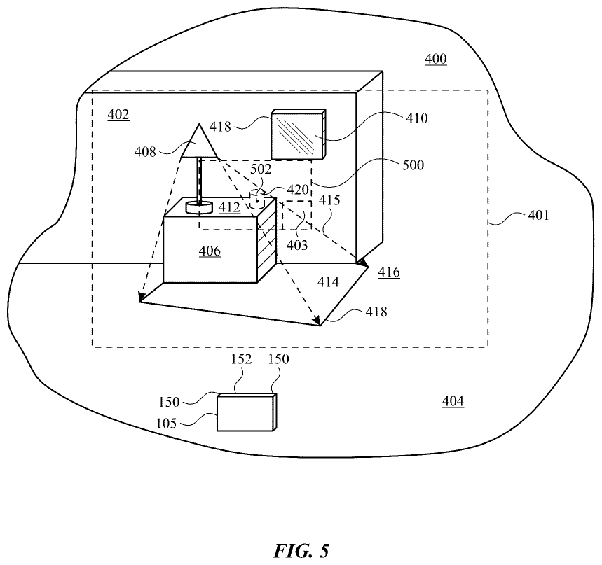

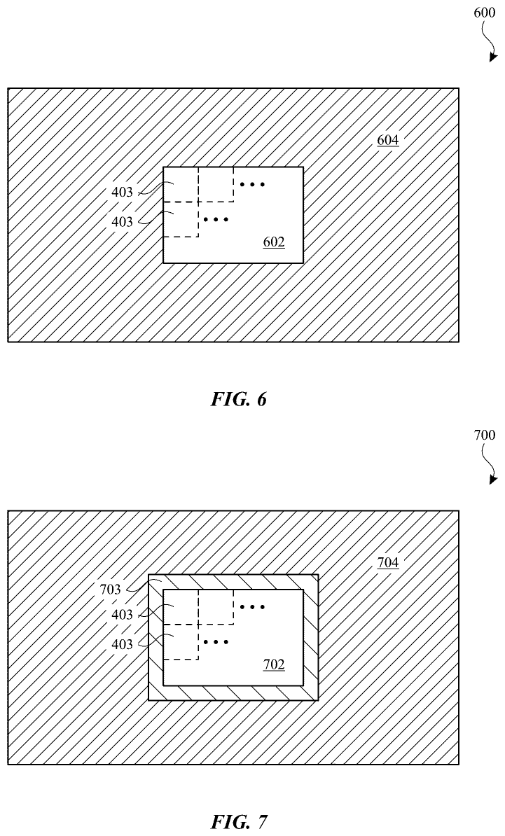

In one or more implementations, the salient region 500 of the physical environment 400 may be identified (e.g., to or by an environmental condition estimator, such as the light estimation process 302, the light estimation process 310, and/or the light estimation process 314) using a saliency map. Illustrative examples of saliency maps are shown in FIGS. 6 and 7. For example, FIG. 6 illustrates a saliency map 600 implemented as a binary saliency map having a salient portion 602 and a non-salient portion 604. For example, the saliency map 600 may have an area that corresponds to the field-of-view 401 of FIGS. 4 and 5, and the salient portion 602 may have an area that corresponds to (e.g., identifies) the salient region 500 of FIG. 5.

As illustrated in FIG. 6, when the saliency map 600 is provided to (or generated by) an environmental condition estimator (e.g., the light estimation process 302, the light estimation process 310, and/or the light estimation process 314), the environmental condition estimator may obtain environmental condition estimates in one or more portions 403 of the physical environment 400 within the salient region of the physical environment as identified by the salient portion 602 of the saliency map 600. In one or more implementations, the salient portion 602 of the saliency map 600 may be centered on, or otherwise based on, the location of a user's gaze. In one or more implementations, the salient portion 602 of the saliency map 600 may be centered on, or otherwise based on, the location of a user gesture. In one or more implementations, the salient portion 602 of the saliency map 600 may be centered on, or otherwise based on, an object in the physical environment that has been determined to be salient to the user. In some examples, the environmental condition estimator may obtain a single environmental condition estimate for the entire salient region identified by the salient portion 602.

FIG. 7 illustrates another example of a saliency map that can be provided to (or generated by) an environmental condition estimator. In the example of FIG. 7, a saliency map 700 includes a high saliency portion 702, a mid-saliency portion 703, and a low saliency portion 704. In one or more implementations, an environmental condition estimator (e.g., the light estimation process 302, the light estimation process 310, and/or the light estimation process 314) that generates or receives the saliency map 700 may obtain environmental condition estimates in one or more portions 403 of the physical environment 400 within the salient region of the physical environment that is identified by the high saliency portion 702 of the saliency map 600.

The environmental condition estimator may also obtain, for example, a single environmental condition estimate for the region of the physical environment 400 that corresponds to the entire mid-saliency portion 703, and may not obtain environmental condition estimates for the region of the physical environment 400 that corresponds to the low saliency portion 704. In one or more implementations, the saliency map 600 may be referred to as a level one saliency map, and the saliency map 700 may be referred to as a level two saliency map. In one or more implementations, saliency maps at other saliency levels may be generated (e.g., a level zero saliency map covering the entire field-of-view 401, a level three saliency map having multiple mid-saliency regions and/or a more granular region of interest, etc.).

In one or more implementations, the electronic device 105 may recursively apply local saliency masks within a region of interest in the physical environment. For example, in one or more implementations, the electronic device 105 may obtain a local lighting condition estimate and/or another local environmental condition estimate by computing estimates at multiple saliency levels (e.g., with multiple corresponding saliency maps) and determining an optimal estimate from the estimates at the multiple saliency levels. For example, recursively determining estimates may include determining an estimate for a particular saliency level based on an estimate in a high saliency portion of the saliency map for that particular saliency level and based on the estimate of the prior saliency level.

In one more implementations, estimates of a local lighting condition or other local environmental condition may include estimates with a temporal dimension. For example, in one or more implementations, an estimate may be weighted based on adjacent temporal estimates (e.g., using temporal locality). For example, a temporal vector estimate SBE (L, T) can be created in some implementations, where L indicates the spatial dimension (e.g., a spatial region in the field-of-view 401), and T indicates a temporal index (e.g., time stamp) of the estimate.

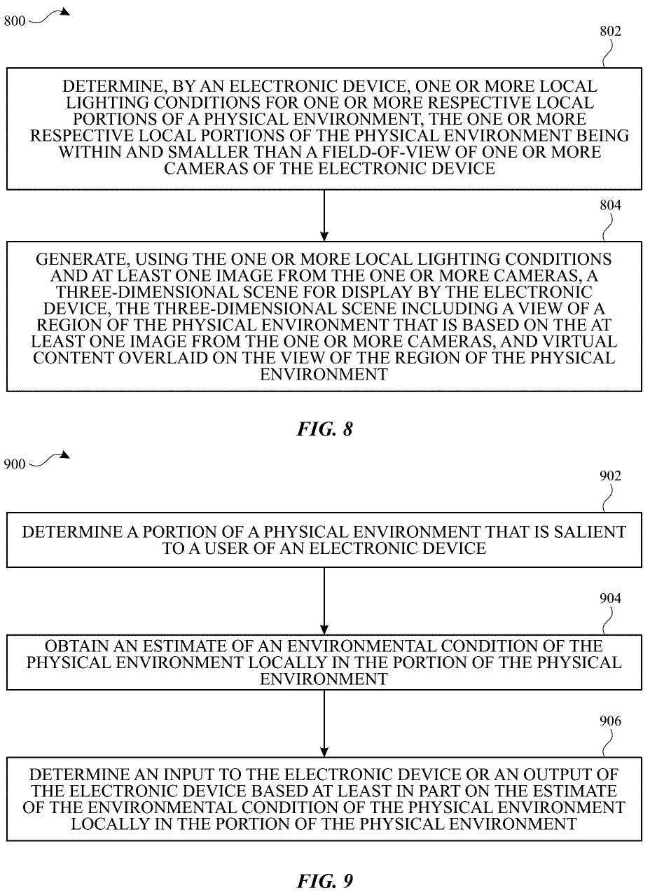

FIG. 8 illustrates an example process 800 for localized environmental input sensing for electronic devices, in accordance with one or more implementations. For explanatory purposes, the process 800 is primarily described herein with reference to the electronic device 105 of FIGS. 1 and 2. However, the process 800 is not limited to the electronic device 105 of FIGS. 1 and 2, and one or more blocks (or operations) of the process 800 may be performed by one or more other components of other suitable devices, including the electronic device 110, the electronic device 115, and/or the servers 120. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In the example of FIG. 8, at block 802, an electronic device (e.g., electronic device 105) may determine one or more (e.g., multiple) local lighting conditions for one or more (e.g., multiple) respective local portions (e.g., local portion 403) of a physical environment (e.g., physical environment 400). At least part of the physical environment (e.g., field of view 401) may be visible by one or more cameras of the electronic device. For example, the one or more respective local portions of the physical environment may be within and smaller than a field-of-view (e.g., field-of-view 401) of one or more cameras of the electronic device. In one or more implementations, each of the one or more local lighting conditions may include an ambient light level in the respective local portion of the physical environment.

In one or more implementations, at least one of the one or more local lighting conditions may include a direction corresponding to a light source (e.g., a direction of the directional light 415 of the physical lamp 408 of FIG. 4). For example, the direction of a light source may be inferred by the electronic device based on detected locations and/or directions of shadows of physical objects in the physical environment. In one or more implementations, the one or more local lighting conditions may include a first local lighting condition on a first side of a light discontinuity (e.g., in the shadow 414 on a first side of the brightness discontinuity 418 of FIG. 4) in the physical environment and a second local lighting condition on a second, opposing, side (e.g., in the lit portion 416 of the physical floor 404 on the other side of the brightness discontinuity 418) of the light discontinuity.

At block 804, the electronic device may determine an input (e.g., a hand gesture or hand location) to the electronic device or an output (e.g., a rendering of a scene, such as a three-dimensional scene or XR scene including virtual content, such as virtual cup 420) of the electronic device using the one or more local lighting conditions. For example, the electronic device may identify a location of a hand or a hand gesture based on the one or more local lighting conditions and at least one image from the one or more cameras. As another example, the electronic device may generate, using the one or more local lighting conditions and at least one image from the one or more cameras, a three-dimensional scene for display by the electronic device, the three-dimensional scene including: a view of a region of the physical environment that is based on the at least one image from the one or more cameras, and virtual content overlaid on the view of the region of the physical environment. For example, the virtual content may be generated based on one or more of the one or more local lighting conditions. For example, a color, a brightness, a shading, a shadow, and/or other properties of the virtual content may be generated based on the local lighting conditions (e.g., an ambient light level, a light direction, a color, a texture, a material, etc.) in the physical environment at the location at which the virtual content is displayed to appear in the physical environment.

In one or more implementations, generating the three-dimensional scene may include providing the one or more local lighting conditions to a processing stage (e.g., image pre-processing operations 304, image pre-processing operations 312, image pre-processing operations 316, or sensor-based process 306) in a processing chain (e.g., one or more of the processing chains depicted in FIG. 3) that includes at least one subsequent processing stage (e.g., sensor-based process 306 or sensor-based process 308) after the processing stage. For example, the processing chain may be configured to perform at least one of: image pre-processing of the at least one image from the one or more cameras, computer vision operations using the at least one image from the one or more cameras, three-dimensional immersion effect generation for the three-dimensional scene, gesture detection, surface texture estimation, scene reconstruction, object tracking, six degree-of-freedom (6DOF) viewing of the virtual content, or spatial audio processing.

In one or more implementations, the process 800 may also include, prior to obtaining the one or more local lighting conditions, determining that the one or more respective local portions of the physical environment are one or more portions of the physical environment that are salient to a user of the electronic device. For example, determining that the one or more respective local portions of the physical environment are one or more portions of the physical environment that are salient to the user may include identifying a salient region of the physical environment, and selecting the one or more respective local portions from within the salient region. In one or more other implementations, a single local lighting condition may be determined for an entire salient region of a physical environment. In one or more implementations, obtaining the one or more local lighting conditions may include recursively obtaining the one or more local lighting conditions using saliency maps (e.g., saliency map 600 and/or saliency map 700) at multiple saliency levels (e.g., as described herein in connection with FIG. 7).

In one or more implementations, determining that the one or more respective local portions of the physical environment are one or more portions of the physical environment that are salient to the user of the electronic device may include detecting a body part of the user in at least one of the one or more respective local portions of the physical environment. In one or more implementations, determining that the one or more respective local portions of the physical environment are portions of the physical environment that are salient to the user of the electronic device may include determining that at least one of the one or more respective local portions of the physical environment is associated with a gaze of the user. In one or more implementations, determining that the one or more respective local portions of the physical environment are portions of the physical environment that are salient to the user of the electronic device may include determining that at least one of the one or more respective local portions of the physical environment is associated with a gesture by the user. In one or more implementations, determining that the one or more respective local portions of the physical environment are portions of the physical environment that are salient to the user of the electronic device may include determining that at least one of the one or more respective local portions of the physical environment is associated with an object in the physical environment (e.g., an object that is often interacted with by the user, often used as an anchor for virtual content, or an object that is otherwise determined to be salient to a user).

In one or more implementations, the process 800 may also include prior to obtaining the one or more local lighting conditions, determining that a region of the physical environment including the one or more respective local portions of the physical environment is salient to a user of the electronic device. For example, the electronic device may determine that the region is salient to the user of the electronic device based on a user action corresponding to the region. For example, the electronic device may determine that the region is salient to the user of the electronic device based on detecting a body part (e.g., a hand) of the user in the region of the physical environment. As another example, the electronic device may determine that the region is salient to the user of the electronic device based on detecting gaze location of a gaze of the user in the region of the physical environment. As another example, the electronic device may determine that the region is salient to the user of the electronic device based on detecting a particular object in the region of the physical environment.

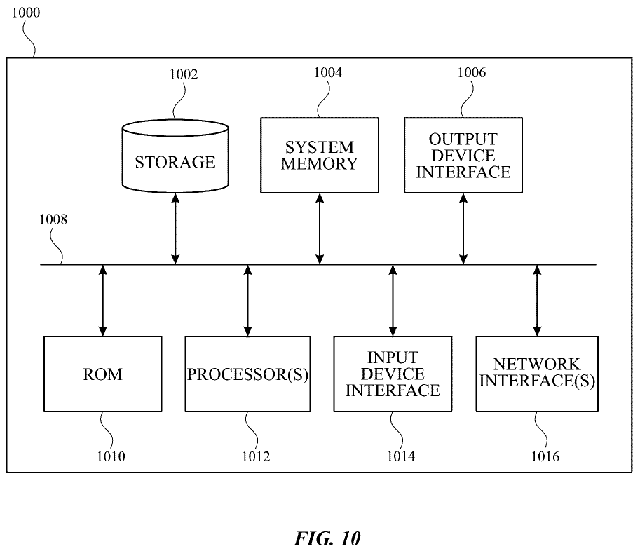

FIG. 9 illustrates an example process 900 for localized environmental input sensing in a salient region of a physical environment, in accordance with one or more implementations. For explanatory purposes, the process 900 is primarily described herein with reference to the electronic device 105 of FIGS. 1 and 2. However, the process 900 is not limited to the electronic device 105 of FIGS. 1 and 2, and one or more blocks (or operations) of the process 900 may be performed by one or more other components of other suitable devices, including the electronic device 110, the electronic device 115, and/or the servers 120. Further for explanatory purposes, some of the blocks of the process 900 are described herein as occurring in serial, or lincarly. However, multiple blocks of the process 900 may occur in parallel. In addition, the blocks of the process 900 need not be performed in the order shown and/or one or more blocks of the process 900 need not be performed and/or can be replaced by other operations.

In the example of FIG. 9, at block 902, an electronic device (e.g., electronic device 105) may determine a portion (e.g., salient region 500) of a physical environment (e.g., physical environment 400) that is salient to a user of an electronic device (e.g., as described herein in connection with FIG. 5).

At block 904, the electronic device may obtain an estimate of an environmental condition (e.g., a local lighting condition or other local environmental condition) of the physical environment locally in the portion of the physical environment. In one or more implementations, the electronic device may obtain multiple estimates of the environmental condition in multiple local regions (e.g., portions 403) within the portion of the physical environment that is salient to the user. In one or more implementations, the electronic device may obtain the estimate of the environmental condition recursively using multiple resolutions and saliency levels (e.g., as described herein in connection with FIG. 7).

At block 906, the electronic device may determine an input (e.g., a hand gesture) to the electronic device or an output (e.g., a rendering of a scene, such as a three-dimensional scene or XR scene including virtual content, such as virtual cup 420) of the electronic device based at least in part on the estimate of the environmental condition of the physical environment locally in the portion of the physical environment. For example, the electronic device may determine the input or the output by providing the estimate of the environmental condition to image pre-processing operations, and/or one or more sensor-based processes (e.g., as described herein in connection with FIG. 3). In one or more implementations, determining the input or the output may include generating, based at least in part on the estimate of the environmental condition of the physical environment locally in the portion of the physical environment, a three-dimensional scene for display by the electronic device, the three-dimensional scene including: a view of a region of the physical environment that is based on at least one image from one or more cameras, and virtual content overlaid on the view of the region of the physical environment (e.g., as described herein in connection with block 804 of FIG. 8).

In one or more implementations, a method may be provided that includes: determining, by an electronic device, one or more local lighting conditions for one or more respective local portions of a physical environment, the one or more respective local portions of the physical environment within and smaller than a field-of-view of one or more cameras of the electronic device; and performing, using the one or more local lighting conditions (e.g., and at least one image from the one or more cameras) a spatial computing operation (e.g., detecting a user interaction, and/or generating a spatial image, spatial audio, and/or spatial video).

In one or more implementations, a method may be provided that includes: determining, by an electronic device, one or more local lighting conditions for one or more respective local portions of a physical environment, the one or more respective local portions of the physical environment within and smaller than a field-of-view of one or more cameras of the electronic device; detecting a user input to the electronic device based on the one or more local lighting conditions.

As described above, one aspect of the present technology is the gathering and use of data available from specific and legitimate sources for providing localized environmental input sensing for electronic devices. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for providing localized environmental input sensing for electronic devices.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the localized environmental input sensing for electronic devices, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 10 illustrates an electronic system 1000 with which one or more implementations of the subject technology may be implemented. The electronic system 1000 can be, and/or can be a part of, the electronic device 105, the handheld electronic device 104, the electronic device 110, the electronic device 115, and/or the server 120 as shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010 (which are each implemented as a non-transitory computer-readable medium). From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes, such as the electronic device 110 shown in FIG. 1, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
determining, by an electronic device, one or more local lighting conditions for one or more respective local portions of a physical environment, wherein the one or more respective local portions of the physical environment are within and smaller than a field-of-view of one or more cameras of the electronic device; and
generating, using the one or more local lighting conditions and at least one image from the one or more cameras, a three-dimensional scene for display by the electronic device, the three-dimensional scene including: a view of a region of the physical environment that is based on the at least one image from the one or more cameras, and virtual content overlaid on the view of the region of the physical environment.

2. The method of claim 1, wherein each of the one or more local lighting conditions includes an ambient light level in the respective local portion of the physical environment.

3. The method of claim 2, wherein at least one of the one or more local lighting conditions includes a direction corresponding to a light source.

4. The method of claim 1, wherein generating the three-dimensional scene comprises providing the one or more local lighting conditions to a processing stage in a processing chain that includes at least one subsequent processing stage after the processing stage.

5. The method of claim 4, wherein the processing chain is configured to perform at least one of: image pre-processing of the at least one image from the one or more cameras, computer vision operations using the at least one image from the one or more cameras, three-dimensional immersion effect generation for the three-dimensional scene, gesture detection, surface texture estimation, scene reconstruction, object tracking, spatial computing, six degree-of-freedom display of the virtual content, or spatial audio processing.

6. The method of claim 4, wherein the one or more local lighting conditions include a first local lighting condition on a first side of a light discontinuity in the physical environment and a second local lighting condition on a second, opposing, side of the light discontinuity.

7. The method of claim 1, further comprising, prior to obtaining the one or more local lighting conditions, determining that the one or more respective local portions of the physical environment are one or more portions of the physical environment that are salient to a user of the electronic device.

8. The method of claim 7, wherein determining that the one or more respective local portions of the physical environment are one or more portions of the physical environment that are salient to the user of the electronic device comprises detecting a body part of the user in at least one of the one or more respective local portions of the physical environment.

9. The method of claim 7, wherein determining that the one or more respective local portions of the physical environment are one or more portions of the physical environment that are salient to the user of the electronic device comprises determining that at least one of the one or more respective local portions of the physical environment is associated with a gaze of the user.

10. A non-transitory machine readable medium comprising instructions which, when executed by one or more processors, causes the one or more processors to perform operations comprising:
determining, by an electronic device, a plurality of local lighting conditions for a plurality of respective local portions of a physical environment, at least part of the physical environment being visible by one or more cameras of the electronic device; and
generating, using the plurality of local lighting conditions and one or more images from the one or more cameras, a three-dimensional scene for display by the electronic device, the three-dimensional scene including: a view of a region of the physical environment that is based on the one or more images from the one or more cameras, and virtual content overlaid on the view of the region of the physical environment.

11. The non-transitory machine readable medium of claim 10, wherein each of the local lighting conditions includes an ambient light level in the respective local portion of the physical environment.

12. The non-transitory machine readable medium of claim 11, wherein at least one of the local lighting conditions includes a direction corresponding to a light source in the respective local portion of the physical environment.

13. The non-transitory machine readable medium of claim 10, wherein the operations further comprise determining one of a local color or a local texture using at least one of the plurality of local lighting conditions.

14. The non-transitory machine readable of claim 10, wherein generating the three-dimensional scene comprises providing the plurality of local lighting conditions to a processing stage in a processing chain that includes at least one subsequent processing stage after the processing stage.

15. The non-transitory machine readable of claim 10, wherein the plurality of local lighting conditions include a first local lighting condition on a first side of a light discontinuity in the physical environment and a second local lighting condition on a second, opposing, side of the light discontinuity.

16. The non-transitory machine readable of claim 10, the operations further comprising, prior to obtaining the plurality of local lighting conditions, determining that the plurality of respective local portions of the physical environment are portions of the physical environment that are salient to a user of the electronic device.

17. An electronic device comprising:
a memory; and
at least one processor configured to:
determine a plurality of local lighting conditions for a plurality of respective local portions of a physical environment, at least part of the physical environment being visible by one or more cameras of the electronic device; and
generate, using the plurality of local lighting conditions and one or more images from the one or more cameras, a three-dimensional scene for display by the electronic device, the three-dimensional scene including: a view of a region of the physical environment that is based on the one or more images from the one or more cameras, and virtual content overlaid on the view of the region of the physical environment.

18. The electronic device of claim 17, wherein the at least one processor is further configured to, prior to obtaining the plurality of local lighting conditions, determine that a region of the physical environment including the plurality of respective local portions of the physical environment is salient to a user of the electronic device.

19. The electronic device of claim 18, wherein the at least one processor is further configured to determine that the region is salient to the user of the electronic device based on a user action corresponding to the region.

20. The electronic device of claim 17, wherein the plurality of local lighting conditions include a first local lighting condition on a first side of a light discontinuity in the physical environment and a second local lighting condition on a second, opposing, side of the light discontinuity.
